(19) United States
(12) Patent Application Publication
(10) Pub. No.: US 2017/0012495 A1
(43) Pub. Date: Jan. 12, 2017

(54) Vibration Damper Comprising A Generator Connection

(71) Applicant: ZF FRIEDRICHSHAFEN AG, Friedrichshafen (DE)

(72) Inventors: Robert PRADEL, Röthlein (DE); Helmut BAALMANN, Bergtheinfeld (DE); Andreas FÖRSTER, Schweinfurt (DE); Eberhard SIMON, Gochsheim (DE); Achim THOMAE, Bergheinfeld (DE); Sebastian SCHNEIDER, Dresden (DE)

(21) Appl. No.: 15/116,469

(22) PCT Filed: Jan. 8, 2015
(86) PCT No.: PCT/EP2015/050199

§ 371 Date: Aug. 3, 2016

(30) Foreign Application Priority Data
Feb. 4, 2014 (DE) 10 2014 201 960.5

(51) Int. Cl. H02K 7/18; F16D 3/12; F03G 7/08; F16F 15/023; F01D 5/02; F01D 15/10; B60G 13/14; F16D 3/14

(52) U.S. Cl. CPC H02K 7/1823; B60G 13/14; F16D 3/12; F16D 3/14; F16F 15/0235; F01D 5/02; F01D 15/10; H02K 7/1853; F03G 7/08; B60G 2202/22; B60G 2202/23; B60G 2202/24; B60G 2202/416; B60G 2300/60; F16D 2300/22

(57) ABSTRACT

A vibration damper having a cylinder filled with pressurized medium and a displacer that drives a generator. The vibration damper has a resilience element that compensates pressure peaks from the displacer movement relative to the generator. The resilience element is constructed as a torsion damper for the generator.

### CROSS REFERENCE TO RELATED APPLICATIONS

This is a U.S. national stage of application No. PCT/EP2015/050199, filed on Jan. 8, 2015. Priority is claimed on German Application No. DE102014201960.5 filed Feb. 4, 2014, the content of which is incorporated here by reference.

### BACKGROUND OF THE INVENTION

1. Field of the Invention

The invention is directed to a vibration damper with a generator connection.

2. Description of the Prior Art

DE 10 2009 056 874 A1 discloses a vibration damper for a vehicle in which a hydraulic cylinder of a vibration damper is connected to a generator that converts a stroke movement of the vibration damper at least partially into electrical energy. As conventionally used, a vibration damper is subjected to a very wide variety of excitations which can lead to load peaks at the generator. These load peaks manifest themselves as noise, for example, or result in damage to the system.

As a solution, DE 10 2009 056 874 A1 proposes a storage filled with pressurized medium by which the pressure peaks are cushioned. But a storage of this type can lead to added costs in connection with one of the line systems inside and/or outside of the vibration damper.

### SUMMARY OF THE INVENTION

It is an object of the present invention to find an alternative solution for the problem of pressure peaks occurring within the vibration damper.

This object is met according to one aspect of the invention in that a resilience element is constructed as a torsion damper for the generator. Instead of a hydraulic storage, which necessitates an installation space that is not to be underestimated, a purely mechanical torsion damper is used.

In a further advantageous configuration, the torsion damper has an input element, an output element, and a spring element arranged between the input and output elements. Practically any spring can be used as spring element, but helical springs, because of their comparatively large spring deflection, or elastomer springs, owing to their simple constructional form and high load limit, have turned out to be particularly advantageous.

According to an advantageous aspect, the torsion damper has a vibration damper. This vibration damper counteracts the operating movement of the torsion damper and imposes a decay function on the latter.

As vibration damper of the torsion damper, a friction damper has proven to be particularly simple and entirely sufficient for the application.

For purposes of a compact constructional form, it is provided that the torsion damper is arranged between a turbine driven by the displacer and an electric machine as parts of the generator. It is conceivable in this arrangement that a well-known turbine is arranged as a constructional unit, the torsion damper is arranged as a constructional unit, and the electric machine is arranged as a constructional unit. Insofar as necessitated by the installation space conditions, it can also be provided that the torsion damper is arranged between the input side and output side of the turbine.

In a further constructional elaboration, the turbine, torsion damper and electric machine are arranged in a common housing.

### BRIEF DESCRIPTION OF THE DRAWINGS

The invention will be described more fully with reference to the following description of the drawings.

FIG. 1 is a schematic view of the vibration damper with a generator;

FIGS. 2-4 are a torsion damper;

FIGS. 5-7 are a torsion damper with a friction damper.

### DETAILED DESCRIPTION OF THE PRESENTLY PREFERRED EMBODIMENTS

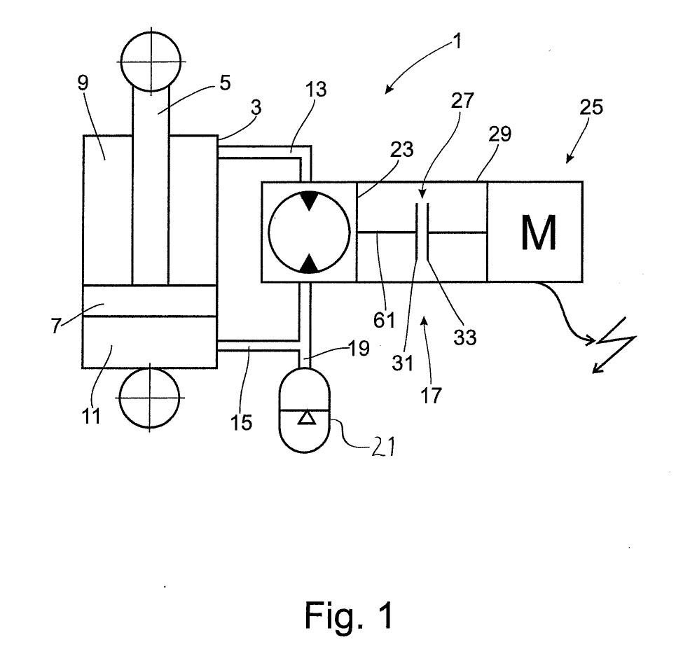

FIG. 1 shows a schematic view of a vibration damper 1 of any constructional type, i.e., monotube vibration damper or twin-tube vibration damper. A piston rod 5, possibly with a piston 7 as displacer, is guided so as to be axially movable in a cylinder 3. Both working chambers 9; 11 of cylinder 3 are completely filled with pressurized medium such that a movement of the displacer conveys pressurized medium through lines 13; 15 to a generator 17 that converts the movement of the displacer into electrical energy.

The vibration damper 1 further comprises, in a bypass line 19 to line 15, and a storage that serves to compensate the pressurized medium volume displaced from the cylinder 3 by the piston rod 5. The storage 21 is compressively preloaded such that a pressure volume occurring when the displacer moves into the working chamber 11 is also supplied primarily to the generator 17.

The generator 17 comprises a turbine 23 driven by the displaced pressurized medium. The turbine 23 drives an electric machine 25 that generates the electrical energy. The generator 17 further comprises a torsion damper 27 as resilience element that smooths pressure peaks in the pressurized medium or at the turbine 23. But the generator 17 can also function as motor when connected to a power source.

The torsion damper 27 is functionally arranged between turbine 23 and electric machine 25. The torsion damper can be used as a separate constructional unit or as a component part, e.g., of the turbine. In the present instance, all of the components of the generator 17 are arranged in a common housing 29.

FIGS. 2 to 4 show a first embodiment form of the torsion damper 27 which has an input element 31 from the turbine 23 and an output element 33 to the electric machine 25 and at least one spring element 35 arranged between the two elements 31; 33. The output element 33 has a carrier disk 37 with axial, segment-like projections 39. Elastomer bodies are supported in circumferential direction as spring elements 35. In this embodiment example, the input element has three projections 39 cooperating with six elastomer bodies 35. As can be seen from FIG. 3, the elastomer bodies 35 in pairs respectively delimit an engagement region 41 for the disk-shaped input element 3,1 which has three ribs 43 (FIG. 4) projecting into the engagement region 41 and substantially filling the latter as is shown in FIG. 2. The ribs 43 have torque transmission surfaces 45, just as projections 39 have torque transmission surfaces 47. Torque transmission surfaces 45 in turn delimit a receiving region 49 for projections 39 and elastomer bodies 35. Bolts 51 axially connect the input element 31 and output element 33, extend through elongated holes 53 of the output element 33 and are fixed in fastening holes 55 of the input element 31 so that the two elements 31; 33 are held together. The output element 33 has a hub flange 57 with a guide surface 59 for the input element 31.

A pressure peak in the hydraulic region of the vibration damper 1 also acts on a shaft 61 (FIG. 1) between the turbine 23 and the electric machine 25. This shaft 23 is constructed to be divided, and the torsion damper 27 is arranged between the two shaft portions. The pressure peak acts in circumferential direction on the input element 31 of the torsion damper 27. The electric machine 25 has a mass inertia that acts counter to the rotational movement of the shaft 61. The input torque at the input element 31 and the mass moment of inertia at the output element 33 of the torsion damper 27 provide for a relative movement between the input element 31 and output element 33, which is compensated by the elastomer bodies 35.

FIGS. 5 and 6 show a torsion damper 27 as subassembly arranged on the shaft 61 between the turbine 23 and electric machine 25. The torsion damper 17 comprises, as input element, a hub disk 63 having a shaft receptacle profile of any type for transmitting torque. The hub disk 63 has a hub flange 65 to which cover disks 67; 69 are fastened laterally. A rivet connection 71 is shown by way of example. The cover disks 67; 69 and an outer lateral surface of the hub disk define an annular space in which a driver disk 73 serving as output element is supported so as to be displaceable in circumferential direction. Further, at least one friction disk 75 is arranged in the annular space between the driver disk 73 and a cover disk 67; 69. All of the disk bodies 67; 69; 73 have windows 77 for receiving at least one helical spring as spring element 35. In this way, the driver disk 73 can move rotationally with respect to the hub disk 63, and the helical springs 35 are preloaded.

This constructional form of a torsion damper 27 has a vibration damper constructed in the manner of a friction damper. Theoretically in a torsion damper, an external excitation would lead to an infinitely long oscillating movement between the input element 61 and the output element 73. The friction-loaded relative movement between the driver disk 73 and the at least one friction disk 75 allows the oscillating movement to decay quickly.

The construction according to FIG. 7 shows a torsion damper 27 constructed in a manner like the principle according to FIGS. 2 to 4. However, helical springs 35 are used instead of elastomer bodies. Further, this torsion damper 27 also has a vibration damper constructed in the manner of a friction damper. The output element 33 has a polygonal lateral surface 79 such that a radial reduction of the engagement region 41 is caused during a relative movement between the input element 31 and output element 33. Accordingly, radially preloaded friction bodies 81 become operative depending upon rotational angle. The friction bodies 81 guide the helical springs 35 and are supported radially between the input element 31 and output element 33. If the radial distance between the polygonal lateral surface 79 of the output element 33 and a concentric friction surface 83 of the input element 31 changes, the frictional effect of the vibration damper also changes.

The connection surfaces connecting to the shaft 61 have not been shown in the drawings.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-6. (canceled)

7. A vibration damper assembly comprising:
a generator;
a cylinder filled with pressurized medium having a displacer configured move in the cylinder and drive the generator; and
a resilience element configured as a torsion damper that compensates for pressure peaks from the displacer movement relative to the generator.

8. The vibration damper according to claim 7, wherein the torsion damper comprises:
an input element;
an output element; and
at least one spring element arranged between the input element and the output element.

9. The vibration damper according to claim 7, wherein the torsion damper has a vibration damper.

10. The vibration damper according to claim 9, wherein the vibration damper of the torsion damper is a friction damper.

11. The vibration damper according to claim 7, wherein the generator comprises a turbine driven by the displacer and an electric machine, wherein the torsion damper is arranged between the turbine and the electric machine.

12. The vibration damper according to claim 7, wherein a turbine, the torsion damper and an electric machine are arranged in a common housing.

13. The vibration damper according to claim 11, wherein the turbine, the torsion damper and the electric machine are arranged in a common housing.
